(19) United States
(12) Patent Application Publication
(10) Pub. No.: US 2004/0079626 A1
(43) Pub. Date: Apr. 29, 2004

(54) Smart/variable circuit breaker for automotive and other applications

(76) Inventor: Ataul Haq, Alexandria, VA (US)

Correspondence Address: ATAUL HAQ, 5340 HOLMES RUN PKWY. # 1412, ALEXANDRIA, VA, 22306, US

(21) Appl. No.: 10/685,532

(22) Filed: Oct. 16, 2003

Related U.S. Application Data
(60) Provisional application No. 60/418,354, filed on Oct. 16, 2002.

(51) Int. Cl. H01H 29/16; H01H 9/00

(52) U.S. Cl. 200/308

(57) ABSTRACT

A non-conventional electrical circuit breaker with multiple cut-off threshold points, governed by built-in feed-back sensing circuits, which manipulates the tripping threshold values by sensing different requirements of maximum draw of current depending on the required circuit conditions and states of the application.

### CROSS REFERENCE TO THE RELATED APPLICATION

This application claims the benefit of U.S. Provisional Patent Application Serial No. 60/418,354, filed Oct. 16, 2002

### BACKGROUND OF THE INVENTION

1. Field of the Invention

The present invention generally relates to safety devices. More specifically, the present invention is drawn to a apparatus for preventing accidental discharge of current of the source battery or generating system beyond the required draw of current during a particular state of the system by automatically adjusting the tripping threshold value of this device thereby, preventing the excessive draw of the current through the circuit.

2. Description of Related Art

Several devices have been invented to mechanically adjust the tripping value of a circuit breaker. However, no prior art is drawn to address the issue of automatically in order to provide unnecessary protection against draw of the current through the circuit.

In our daily life we all encounter situation where our equipment and machines are required to have different machines, equipments and gadgets requiring different electrical state depending on use. For example in automotive applications, the current requirement of the electrical system is different during ignition “OFF” position and during ignition “ON” position. However, the protection of the circuit remains at a fixed rated value. With the invention of this smart/variable circuit breaker this apparatus will provide protection at the different state of the circuit automatically. For example U.S. Pat. No. 5,821,485, Singer, et al., U.S. Pat. No. 6,135,633 DiMarco, et at and U.S. Pat. No. 6,396,373 Gerdes, et al show devices where the trip calibration done mechanically or tripping is done based on external conditions but not the circuit state and conditions. Therefore making the device non-responsive to the circuit state and conditions. Other prior arts, for example U.S. Pat. No. 6,020,656 Fildan, U.S. Pat. No. 4,754,159 Pointout, et al and U.S. Pat. No. 4,176,284 Higgs shows devices to cutt -off automotive battery from the main circuit by the operator or during impact accident. None of these devices addresses the different state of the circuit requirement and the respective safety. All these devices have fixed protection based on fixed event drawn to a specific fixed situation.

### SUMMARY OF THE INVENTION

This smart/variable circuit breaker comprises of non-conventional built-in electronic circuits which when receives feedback signals from the circuit can adjust the tripping threshold values of the breaker in the application. This smart/variable circuit breaker (SVCB) can be very useful in automotive application for newer or older models. It is a retrofit-able device, which when installed in automotive shall provide complete protection from accidental drainage of the battery caused by any event or malfunction during the ignition off position. At the ignition “ON” position the circuit breaker's trip value is raised automatically to its maximum rating, and when the ignition of the vehicle is at “OFF” position the tripping threshold value drops to a system's minimum requirement of the current flow. Therefore, during the shutdown position any draw of current over the minimum draw requirement will trip the breaker and will energize a signal for operator to know the trip conditions. Whereas, during the full draw condition the breaker will not trip due to high threshold setting, which is governed by the feedback sensing circuit. Other applications could be electrical household devices in order to provide safety to children in case of accidental use. This SVCB can operate on DC/AC and are very economical to manufacture and yet the benefits are astronomical.

### BRIEF DESCRIPTION OF DRAWINGS

FIG. 1 is a perspective drawing of the article of invention “smart/variable circuit breaker as a typical automotive application. FIG. 2 schematic of the article of invention “smart/variable circuit breaker” with visual indicator and electronic reset circuit and switch shown.

### DETAIL DESCRIPTION OF THE PREFERRED EMBODIMENT

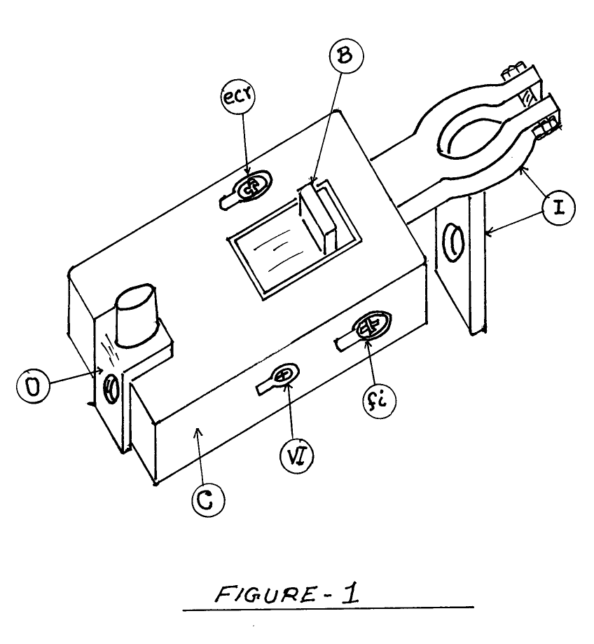

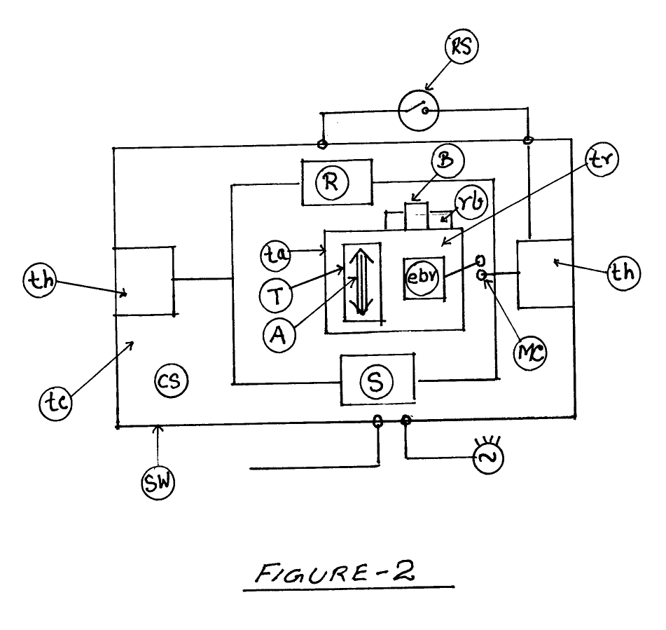

The present invention is in the field of Electrical Circuit Breaker, more specifically, Variable Circuit Breakers with Smart Sensing capabilities built-in the circuit breaker in order to provide additional circuit protections and to provide protection against accidental drainage of batteries, specially in automotives applications. In case of automotive applications, this variable/smart circuit breaker can be retrofitted to any vehicle, newer or older models. This breaker is installed on the positive side of the vehicle battery terminal; the breaker comes with different configuration to fit on all the possible automotive batteries terminal types. This smart/variable circuit breaker (SVCB) is provided with a battery post (extension or screw type), during installation, the main positive wire on the existing battery is removed from the battery post and installed on the SVCB post. The SVCB is than installed on the automotive battery (see FIG. 1).

A feed-back wire is connected to existing fuse box, which turns positive at the “ON” position of the ignition switch of the vehicle, and the other end is connected to the feed-in terminal at the SVCB (see FIG. 1).

During ignition “ON” position the threshold value is raised to a maximum rated draw condition, therefore let maximum flow of current to pass without tripping. This position is sensed via feedback circuit. During ignition “OFF” position, the sensing circuit senses the absence voltage on the feedback circuit and therefore adjusts the tripping threshold value of the SVCB to a minimum rated value of draw of current from the same circuit. During this situation if there is any draw over the minimum rated value will cause the breaker to trip and a visual signaling circuit is energized in order to alert the operator of the trip conditions. At that point the operator can reset the SVCB manually or by optional electronic reset button. This smart/variable smart circuit breaker (SVCB) is an electrical/electronic device, which can operate on both alternating current (AC) and direct current (DC). The device is a non-conventional circuit breaker, which can automatically vary the tripping threshold value of the passing current through the circuit. The typical application is in the automotive field, where this device, SVCB can be retrofit to all the existing vehicles in order to protect the discharge of the battery from accidental drainage or due to malfunction or short caused in the electrical system. Among other applications could be household electrical machines that can be provided with this SVCB to avoid electrical shock for non-Intended, thereby making it a child safe machine or equipment. The SVCB is provided with feedback electronic circuit built-in the circuit breaker itself which when receives signals from the attached circuit about its condition can adjust the tripping threshold value of the circuit breaker. This feedback voltage is sensed through a feedback circuit. A typical retrofit able SVCB is shown in FIG. 1, the typical application is on automotive battery to protect the vehicle battery drainage through the circuit due to electrical short or due to accidental drainage due to any system left on. This typical SVCB consists of, but not limited to the following components, as illustrated in FIG. 1 and FIG. 2;

| | |
|---|---|
| Circuit breaker casing | C |
| Terminal In | I |
| Terminal Out | O |
| Sensing Circuit | S |
| Reset Button | B |
| Reset Circuit | R |
| Tripping Mechanism | T |
| Tripping Adjuster | A |
| Main Contacts | MC |
| Feed-in connector | fi |
| Electronic breaker reset | ebr |
| Electronic reset connect | ecr |
| Reset switch | RS |
| Visual indicator | VI |

Other relevant parts and circuits depending on the applications can vary from the description above and can have more components.

The circuit breaker casing (C) house consists of, but not limited to; side walls (sw), Bottom and top cover (tc) internal circuit chassis (cs), terminal housings (th), reset button housing (rb), tripping mechanism housing (tr) and tripping adjuster housing (ta), as illustrated in FIG. 2.

Terminal In (I) of the SVCB, which connects the breaker into the source point (in typical automotive application it is the terminal that connects to the battery post), as illustrated in FIG. 2. The terminal out (O) of the SVCB, which connects the SVCB to the main circuit (in typical automotive application it connects to the main positive wire) as illustrated in FIG. 2.

Sensing circuit (S) receives signal from the main circuit to which the SVCB is connected via feed-in wire (fi), which determines the tripping threshold requirement of the SVCB. In typical automotive application this feed-in wire (fi) is connected to the positive side of fuse block to any terminal, which is energized with the ignition “ON” position. This feed-in wire signals the sensing circuit to operate the tripping threshold adjuster (A), which in turn operates the tripping mechanism (T) of the SVCB.

During the fault trip of the SVCB, the trip-reset button (B) disengages the main contacts (MC) thereby disengaging the circuit. The operate is required to move the reset button (B) which in turn energized the reset circuit (R) in order to move the main contact (MC) to engage the circuit. The trip reset can also be done electronically via electronic breaker reset circuit by connecting to electronic breaker reset (ebr)

A typical schematic of an automotive SVCB is illustrated in FIG. 3.

I claim:

1. A smart/variable circuit breaker for automotive and other applications, as an article of invention, comprises of, but not limited to, all the components electrical and mechanical, necessary for the performance of this device, which consists of a casing made of side walls, bottom and top cover, internal circuit chassis, terminal housings, reset button housing, tripping mechanism housing, tripping adjuster housing, main contacts, electronic breaker reset circuit, reset circuit, sensing circuit, terminals-in, terminal-out, feed-in, electronic circuit reset connect and all other necessary components and hardware for the functional and cosmetic purpose of the device, including remote visual signal indicator and remote reset switch.

2. The casing as an article of manufacture based on the above claim 1, comprises of, but not limited to, side walls, bottom cover, top cover, chassis for electronic circuit, housing for terminals, housing for reset mechanism, feed-in connections, reset connections, and other necessary hardware for the purpose of the article of invention.

3. The internal electronic circuit as an article of fabrication based on the above claim 1, consists of, but not limited to sensing circuit, reset circuit, breaker reset circuit, electronic links, power circuit, latching circuit and other relevant electronic component necessary for the purpose of the article of invention.

4. The terminals as an article of manufacture based non claim 1, comprises of, but not limited to, terminal-in for connecting to the source having different configurations, terminal-out for connecting to the main circuit having different configuration, terminal for feed-in circuit, terminal for electronic reset circuit and any other relevant terminal necessary for the purpose of the article of invention.

5. The main contacts as an article of fabrication, based on claim 1, consists of, but not limited to, rated contacts made of conducting material having configuration to make faultless positive connection and quick disengagement capability and relevant features necessary for the purpose of the article of the invention.

6. The tripping adjuster mechanism, as an article of fabrication, based on claim 1, comprises of electro-mechanical assembly, consists of inductive coils, core magnets, pivot point, lever, fulcrum point arms and other relevant components essential for the function of the article of invention

7. The feed-in connector as an article of fabrication based on claim 1, comprises of screw terminals, feed-in wiring harness, plug-in connectors, contacts and other relevant components essential for the function of the article of invention.

8. The reset connector as an article of fabrication based on the claim 1, consists of screw terminals, reset wiring harness, plug-connectors, contacts and other relevant components essential for the function of the article of invention.

9. The visual signal indicator as an article of invention based on the claim 1, consists of LED indicators, bulb indicators, indicator wiring harness, LED holder, Bulb holder, connectors, contacts and other relevant components necessary for the function of the article of invention.

10. The electronic reset as an article of fabrication based on claim 1, comprises of reset switch, switch holder, connectors, reset wire harness, contacts and other relevant components essential for the function of the article of invention.
